(19) United States
(12) Patent Application Publication
(10) Pub. No.: US 2018/0293507 A1
(43) Pub. Date: Oct. 11, 2018

(54) METHOD AND APPARATUS FOR EXTRACTING KEYWORDS BASED ON ARTIFICIAL INTELLIGENCE, DEVICE AND READABLE MEDIUM

(71) Applicant: BEIJING BAIDU NETCOM SCIENCE AND TECHNOLOGY CO., LTD., Haidian District Beijing (CN)

(72) Inventors: Rongzhong LIAN, Haidian District Beijing (CN); Zeyu CHEN, Haidian District Beijing (CN); Di JIANG, Haidian District Beijing (CN); Jiajun JIANG, Haidian District Beijing (CN); Jingzhou HE, Haidian District Beijing (CN)

(73) Assignee: BEIJING BAIDU NETCOM SCIENCE AND TECHNOLOGY CO., LTD., Haidian District Beijing (CN)

(21) Appl. No.: 15/945,611

(22) Filed: Apr. 4, 2018

(30) Foreign Application Priority Data
Apr. 6, 2017 (CN) 2017102209161

(51) Int. Cl. G06N 7/00; G06F 17/30

(52) U.S. Cl. CPC G06N 7/005; G06F 17/30702

(57) ABSTRACT

Method and apparatus for extracting keywords based on artificial intelligence, a device and readable medium. Based on a topic model, predicting a distribution probability of a target document in each topic among multiple topics; calculating correlation between word vectors of respective words in multiple words of the target document and topic vectors of respective topics in multiple topics, wherein the word vectors of words and topic vectors of respective topics are all generated based on a word vector model; extracting, from the multiple words, words as keywords of the target document, according to distribution probabilities of words in respective topics and the correlation between the word vectors of the respective words and the topic vectors of the respective topics in multiple topics. Keywords are extracted according to the distribution probabilities of words in topics and the correlation between word vectors of words and topic vectors of topics in multiple topics.

The present application claims the priority of Chinese Patent Application No. 2017102209161, filed on Apr. 6, 2017, with the title of “Method and apparatus for extracting keywords based on artificial intelligence, device and readable medium”. The disclosure of the above applications is incorporated herein by reference in its entirety.

### FIELD OF THE DISCLOSURE

The present disclosure relates to the technical field of computer application, and particularly to a method and apparatus for extracting keywords based on artificial intelligence, a device and readable medium.

### BACKGROUND OF THE DISCLOSURE

Artificial intelligence AI is a new technical science for researching and developing theories, methods, technologies and application systems for simulating, extending and expanding human intelligence. Artificial intelligence is a branch of computer sciences and attempts to learn about the essence of intelligence, and produces a new intelligent machine capable of responding in a manner similar to human intelligence. The studies in the field comprise robots, language recognition, image recognition, natural language processing, expert systems and the like.

In the current era of information explosion, a user is unlikely to browse all documents that might contain relevant information, and keywords are the most important and concise kind of summarization of document information; therefore, extracting keywords from documents for the user's reference is of great significance in helping the user to accurately obtain information and reducing the user's costs in obtaining the information. However, how to automatically extract quite few most important keywords from a long document is very challenging.

Usually, topic information of a document is of great significance for extraction of keywords of the document. Keywords of the document are certainly some words that are closely relevant to the topic of the document. For example, keywords corresponding to an article relating to science and technology more probably include words such as “Internet”. In the prior art, it is feasible to obtain keywords of the document in the following manner: specifically, it is feasible to use a topic model such as Latent Dirichlet Allocatio LDA model to obtain a topic distribution probability p(w|z) of the document (e.g., a probability of appearance of word w under topic 1) and a word distribution probability p(w|z) of the topic (e.g., a probability of appearance of word w under topic 1); then, it is feasible to a generation probability

$$p ( w \vert d ) = {\sum }_{z} p ( w \vert z ) p ( z \vert d )$$

of each word in the document, wherein z represents the topic, d represents a document, and w represents a certain word, and then select the largest K words as keywords of the document according to the generation probability of each word. The word distribution probability p(w|z) of the topic is a probability of appearance of each word under various topics as obtained by making statistics from a preset document repository including documents with diverse topics.

However, the above-mentioned keyword extracting method has a serious inclination to high-frequency words. Under each topic, if a word appears at a higher frequency, a corresponding probability is higher, so the generation probability of the high-frequency word obtained by calculating based on the above formula is larger so that the recall results are mostly high-frequency words under a certain topic. However, high-frequency words appear very extensively in different documents, and sometimes they are undesired keywords such as “we” and “you” in the document. Hence, the keyword extracting solution in the prior art cannot obtain valid keywords, and the extracted keywords have an undesirable accuracy.

### SUMMARY OF THE DISCLOSURE

The present disclosure provides a method and apparatus for extracting keywords based on artificial intelligence, a device and readable medium, to improve the accuracy of the extracted keywords.

The present disclosure provides a method for extracting keywords based on artificial intelligence, the method comprising:

predicting a distribution probability of a target document in each topic among multiple topics, based on a topic model;

calculating correlation between word vectors of respective words in multiple words of the target document and topic vectors of respective topics in multiple topics, wherein the word vectors of respective words and topic vectors of respective topics are all generated based on a word vector model;

extracting, from the multiple words, words as keywords of the target document, according to distribution probabilities of respective words in respective topics and the correlation between the word vectors of the respective words and the topic vectors of the respective topics in multiple topics.

Further optionally, in the above method, the extracting, from the multiple words, words as keywords of the target document, according to distribution probabilities of respective words in respective topics and the correlation between the word vectors of the respective words and the topic vectors of the respective topics in multiple topics specifically comprises:

calculating generation probabilities of respective words in the target document, according to distribution probabilities of respective words in respective topics and correlation between word vectors of respective words and topic vectors of respective topics in multiple topics;

according to the generation probabilities of the respective words in the target document, extracting, from the multiple words, words as keywords of the target document.

Further optionally, in the above method, before calculating correlation between word vectors of respective words in multiple words of the target document and topic vectors of respective topics in the multiple topics, the method further comprises:

obtaining, from a preset word material repository, word vectors of word materials corresponding to the respective words;

obtaining topic vectors of the respective topics from a preset topic vector repository.

Further optionally, in the above method, before obtaining, from a preset word material repository, word vectors of word materials corresponding to the respective words, the method further comprises:

generating the word material repository including several word materials, according to a preset document repository including multiple documents;

according to the respective word materials in the word material repository and co-occurrence information of the word materials with other word materials in respective documents in the document repository, training the word vector model and word vectors of respective word materials;

storing word vectors of the respective word materials in the word material repository.

Further optionally, in the above method, before obtaining topic vectors of the respective topics from a preset topic vector repository, the method further comprises:

obtaining topic identifiers corresponding to the respective word materials;

obtaining topic vectors of topics corresponding to the respective topic identifiers, according to word vectors of the respective word materials in the word material repository, the topic identifiers corresponding to the respective word materials and the trained word vector model;

storing the topic vectors of the respective topics in the topic vector repository.

The present disclosure provides an apparatus for extracting keywords based on artificial intelligence, the apparatus comprising:

a predicting module configured to predict a distribution probability of a target document in each topic among multiple topics, based on a topic model;

a calculating module configured to calculate correlation between word vectors of respective words in multiple words of the target document and topic vectors of respective topics in multiple topics, wherein the word vectors of respective words and topic vectors of respective topics are all generated based on a word vector model;

an extracting module configured to extract, from the multiple words, words as keywords of the target document, according to distribution probabilities of respective words in respective topics and the correlation between the word vectors of the respective words and the topic vectors of the respective topics in multiple topics.

Further optionally, in the above apparatus, the extracting module is specifically configured to:

calculate generation probabilities of respective words in the target document, according to distribution probabilities of respective words in respective topics and correlation between word vectors of respective words and topic vectors of respective topics in multiple topics;

according to the generation probabilities of the respective words in the target document, extract, from the multiple words, words as keywords of the target document.

Further optionally, the apparatus further comprises:

an obtaining module configured to obtain, from a preset word material repository, word vectors of word materials corresponding to the respective words;

the obtaining module further configured to obtain topic vectors of the respective topics from a preset topic vector repository.

Further optionally, the apparatus further comprises:

a generating module configured to generate the word material repository including several word materials, according to a preset document repository including multiple documents;

a training module configured to train the word vector model and word vectors of respective word materials, according to the respective word materials in the word material repository and co-occurrence information of the word materials with other word materials in respective documents in the document repository;

a storing module configured to store word vectors of the respective word materials in the word material repository.

Further optionally, in the above apparatus:

the obtaining module is further configured to obtain topic identifiers corresponding to the respective word materials;

the training module is further configured to obtain topic vectors of topics corresponding to the respective topic identifiers, according to word vectors of the respective word materials in the word material repository, the topic identifiers corresponding to the respective word materials and the trained word vector model;

the storing module is further configured to store the topic vectors of the respective topics in the topic vector repository.

The present disclosure further provides a computer device, comprising:

one or more processors,

a memory for storing one or more programs,

the one or more programs, when executed by said one or more processors, enabling said one or more processors to implement the above-mentioned method for extracting keywords based on artificial intelligence.

The present disclosure further provides a computer readable medium on which a computer program is stored, the program, when executed by a processor, implementing the above-mentioned method for extracting keywords based on artificial intelligence.

According to the method for extracting keywords based on artificial intelligence, the device and the readable medium of the present disclosure, a distribution probability of the target document in each topic among multiple topics is predicted based on the topic model; calculation is conducted for correlation between word vectors of respective words in multiple words of the target document and topic vectors of respective topics in multiple topics, wherein the word vectors of respective words and topic vectors of respective topics are all generated based on a word vector model; words are extracted from multiple words as keywords of the target document, according to distribution probabilities of respective words in respective topics and the correlation between word vectors of respective words and topic vectors of respective topics in multiple topics. With the above technical solution being employed in the present embodiment, the extracted keywords are not high-frequency words, but are extracted according to the distribution probabilities of respective words in respective topics and the correlation between word vectors of respective words and topic vectors of respective topics in multiple topics, so that the extracted keywords are closer to the topic of the target document, more valid and more accurate.

### BRIEF DESCRIPTION OF DRAWINGS

FIG. 1 is a flow chart of an embodiment of a method for extracting keywords based on artificial intelligence according to the present disclosure.

FIG. 2 is structural diagram of a first embodiment of an apparatus for extracting keywords based on artificial intelligence according to the present disclosure.

FIG. 3 is structural diagram of a second embodiment of an apparatus for extracting keywords based on artificial intelligence according to the present disclosure.

FIG. 4 is a structural diagram of an embodiment of a computer device according to the present disclosure.

FIG. 5 is an example diagram of a computer device according to the present disclosure.

### DETAILED DESCRIPTION OF PREFERRED EMBODIMENTS

The present disclosure will be described in detail in conjunction with figures and specific embodiments to make objectives, technical solutions and advantages of the present disclosure more apparent.

FIG. 1 is a flow chart of an embodiment of a method for extracting keywords based on artificial intelligence according to the present disclosure. As shown in FIG. 1, the method for extracting keywords based on artificial intelligence according to the present embodiment may specifically include the following steps:

100: based on a topic model, predicting a distribution probability of a target document in each topic among multiple topics;

A subject for executing the method for extracting keywords based on artificial intelligence according to the present embodiment is an apparatus for extracting keywords based on artificial intelligence. The apparatus for extracting keywords based on artificial intelligence may be an electronic entity apparatus or an apparatus integrated with software.

The method for extracting keywords based on artificial intelligence according to the present embodiment may be applied to various document applications App such as news, to extract valid keywords of each target document for the user's reference. In the method for extracting keywords based on artificial intelligence according to the present embodiment, the selected topic model may be a topic model such as LDA. The topic model may be pre-trained and can predict a distribution probability of any target document in each topic among multiple topics. The multiple topics of the present embodiment may include multiple classes similar to document labels, for example science and technology, education, real estate, recreation, sports and vehicles. The multiple topics in the present embodiment may be preset before the keywords are extracted.

For example, the topic model of the present embodiment may be obtained by training with training documents of multiple known topics, so that the resultant topic model can accurately predict a topic distribution probability of each target document. For example, there is a target document “A B C”; the topic distribution probability of the target document may be obtained by predicting based on the topic model LDA: the distribution probability of topic 1 is p1, the distribution probability of topic2 is p2, and the like. Since the topic model predicts the distribution probability of the target document under each topic, the predicted distribution probability of each topic is a number larger than or equal to 0 and less than or equal to 1; a sum of distribution probabilities of the same target document under all topics is equal to 1.

101: calculating correlation between word vectors of respective words in multiple words of the target document and topic vectors of respective topics in multiple topics, wherein the word vectors of respective words and topic vectors of respective topics are all generated based on a word vector model; In the present embodiment, it is first feasible to perform word segmentation processing for each sentence in the target document to obtain multiple words included by the target document, and then, regarding each word in the target document, obtain word vectors corresponding to the words from a preset [symbol] (word material repository), that is to say, in the present embodiment, the number of word materials included in the preset word material repository and the word vectors corresponding to respective word materials is large enough, and ordinary common words are all included. In the present embodiment, word materials are synonymous with words. For ease of description, words in the word material repository are called word materials; what are obtained from the target document are words; regarding common words obtained from the target document, generally corresponding word materials and corresponding word vectors may be obtained from the word material repository. Furthermore, the word material repository of the present embodiment may further be updated regularly by adding some word materials and word vectors of the word materials. Regarding some words which are rare and appear in the document at a lower frequency, it is feasible to use a word vector model to train word vectors of these words, and update and store them in the word material repository. The word vectors of all word materials in the word material repository in the present embodiment all may be obtained by predicting based on co-occurrence information of the word materials with other word materials in the context of the document. In the present embodiment, a word vector of each word may solely identify the word, and the word vector can further characterize semantic correlation of the word and other words. For example, when two words are closer to each other in meaning, there is a larger correlation between the word vectors of the two words; if the two words are completely semantically irrelevant, there is a smaller correlation between the word vectors of the two words. In the present embodiment, it is further possible to use a form similar to word vectors to represent a topic, i.e., obtain a topic vector. Since the topic also has a certain meaning and usually meaning of a word in the document under a certain topic is closer to the topic of the document, it may be believed that the word has a larger correlation with the topic so that the topic vector corresponding to the topic may be pre-trained based on already-obtained word vectors and word vector model. Regarding each topic, it is feasible to obtain a corresponding topic vector by training in a similar manner; and store each obtained topic vector in a topic vector repository so that the corresponding topic vector can be directly acquired from the topic vector repository upon use.

For example, at this time, before step 101 “calculating correlation between word vectors of respective words in multiple words of the target document and topic vectors of respective topics in multiple topics”, the method may specifically further comprise the following steps:

(a1) obtaining, from a preset word material repository, word vectors of word materials corresponding to respective words;

(a2) obtaining topic vectors of respective topics from a preset topic vector repository.

Further optionally, before step (a1) “obtaining, from a preset word material repository, word vectors of word materials corresponding to respective words”, the method may further comprise the following steps:

(b1) generating the word material repository including several word materials, according to a preset document repository including multiple documents;

(b2) training the word vector model and word vectors of respective word materials, according to respective word materials in the word material repository and co-occurrence information of the word materials with other word materials in respective documents in the document repository;

(b3) storing word vectors of respective word materials in the word material repository.

In the present embodiment, it is feasible to pre-collect a plurality of documents to form a document repository; perform word segmentation processing for each sentence in each document in the document repository to obtain several word materials, and aggregate said several word materials to generate the word material repository. In the present embodiment, word materials have the same sense as words. In the present embodiment, words obtained from the preset document repository are called word materials to facilitate description. Then, the word vector model and word vectors of respective words are trained according to co-occurrence information of each word material with other word materials in the context of the document. For example, the word vector model and word vectors of respective words are all set as having an initial value. It is feasible to, upon training, obtain word materials co-occurring with the word material as training positive word materials according to the context of the word material, and then, again according to the context of the word material, obtain, from several word materials, word materials that might not co-occur with the word material as negative word materials of the word material. Optionally, the number of the negative word materials may be four times or other integer times the number of positive word materials. Then, it is feasible to input the word material, the positive word materials corresponding to the word material and the negative word materials corresponding to the word material into the word vector model as a set of training data, so that the word vector model outputs the word vector of the word material, the word vectors of the positive word materials and word vectors of the negative word materials. Since the positive word materials co-occur with the word material and the negative word materials cannot co-occur with the word material, the correlation between the word vector of the word material and the word vectors of the positive word materials is required to be larger, for example, larger than or equal to a preset correlation threshold, and the correlation between the word vector of the word material and word vectors of the negative word materials is required to be smaller, for example, smaller than the preset correlation threshold. If the word vector of the word material, word vectors of positive word materials and the word vectors of the negative word materials as output by the word vector model do not satisfy the above conditions, it is feasible to adjust parameters of the word vector model and adjust values of elements in the word vectors of respective word materials to enable the word vector of the word material, word vectors of positive word materials and the word vectors of the negative word materials to satisfy the above conditions.

Upon training, it is feasible to, regarding each set of training data, first adjust parameters of the word vector model to enable the word vector of the word material, word vectors of positive word materials and the word vectors of the negative word materials to satisfy the above conditions; otherwise, when the above conditions are not yet satisfied, adjust values of elements in the word vector of the word materials to enable the word vector of the word material, word vectors of positive word materials and the word vectors of the negative word materials as output by the word vector model to satisfy the above conditions. Upon completion of training of each set of training data, next set of training data is used for continued training. Upon training with next set of training data, word vectors duly trained previously are fixed and no longer adjusted; in a similar way, numerous sets of training data comprised of word materials in the word material repository are used to train the word vector model until the following conditions are satisfied without adjusting the word vector of each word material in the word material repository and parameters of the word vector model: the word vector of the word material output by the word vector model, and the correlation between word vectors of word materials co-occurring with the word material in the same context is larger than or equal to the preset correlation threshold; the correlation between word vectors of word materials not co-occurring with the word material in the same context is smaller than the preset correlation threshold, whereupon parameters of the word vector model are definite and the word vector model is definite. Word vectors of word materials in the word material repository finally obtained by training are stored in the word material repository. That is to say, word materials stored in the word material repository may be stored in the following manner: word materials-word material vectors. Furthermore, it is further feasible to store times of occurrence of the word material in all documents in the document repository, whereupon the corresponding storage manner may be: word materials-word material vectors-times of occurrence.

In addition, optionally, in the present embodiment, if the word vector of the word material, word vectors of positive word materials and the word vectors of the negative word materials as output by the word vector model do not satisfy conditions that the correlation between the word vector of the word material and the word vectors of positive word materials is larger than or equal to a preset correlation threshold, and the correlation between the word vector of the word material and the word vectors of negative word materials is smaller than a preset correlation threshold, it is feasible to only adjust values of elements in the word vectors of respective word materials, namely, only adjust the word vector of the word material, word vectors of positive word materials and the word vectors of the negative word materials to enable the word vector of the word material, word vectors of positive word materials and the word vectors of the negative word materials to satisfy the above conditions. The remaining procedure is identical with the abovementioned procedure of simultaneously adjusting the parameters of the word vector model and adjusting values of elements in the word vectors of respective word materials. For particulars, please refer to the depictions of the above embodiment. No detailed description are presented any more here.

In the prior art, a word representation method which is most visual and most frequently-used so far based on a natural language process NLP model is One-hot Representation. In this method, each word is represented as a very long word vector. The dimension of the word vector is a word list size, and the word list size is equal to the number of words according to beforehand statistics. A majority of elements in the word vector is 0, only one dimension has a value 1, and this dimension represents the current word. For example, the word vector of “ [symbol] (micropone)” may be represented as [0 0 0 1 0 0 0 0 0 0 0 0 0 0 0 0 . . . ], and the word vector of “ [symbol] (microphone)” may be represented as [0 0 0 0 0 0 0 0 1 0 0 0 0 0 0 0 . . . ]. However, such word vector representation manner has an important issue, namely, “word gap” phenomenon: any two words are isolated. Whether there is a relationship between the two words cannot be seen only from the two word vectors, even synonyms such as [symbol] and [symbol] ⇄.

Based on the above current technical problems of word vectors, the word vector of the present embodiment intends to mine textual semantic information through co-occurrence information between words, and furthermore, the word vector of the present embodiment may employ a low-dimension real number vector to represent each word. For example, after training, the word “ [symbol] ” may be represented as “[0.792, −0.177, −0.107, 0.109, −0.542, . . . ], and the word “ [symbol] ” may be represented as [0.722, −0.127, −0.187, 0.119, −0.542, . . . ]. The dimension of the word vector of the present embodiment is by far smaller than the word list size, for example, 128 dimensions, 64 dimensions or other 2ⁿ dimensions. Most importantly, the largest contribution made by the word vector of the present embodiment is that the correlation between two words can be measured by measuring the correlation of word vectors, for example, “ [symbol] ” and “ [symbol] ” are closer to each other in meaning; the correlation between the two word vectors might be larger, for example, may be larger than or equal to the preset correlation threshold.

In addition, since in the present embodiment, the word vectors of the word materials corresponding to respective words are obtained from the preset word material repository, before step 101 “calculating correlation between word vectors of respective words in multiple words of the target document and topic vectors of respective topics in multiple topics”, the method may further comprise determining multiple words of the target document. That is to say, in the present embodiment, it is unnecessary to perform the above processing for each word in the target document; it is feasible to first perform word segmentation processing for each sentence in the target document to obtain numberless words, and then filter the numberless words according to the word material repository to remove words without corresponding word materials in the word material repository. The multiple words obtained in this way all have corresponding word vectors in the word material repository and may participate in subsequent keyword extraction. Since the word material repository of the present embodiment includes sufficient word materials, it may be believed in the present embodiment that the words fileted away all are some non-critical words in the document which are relatively rare with a small occurrence probability.

Alternatively, before step 101 “calculating correlation between word vectors of respective words in multiple words of the target document and topic vectors of respective topics in multiple topics”, after performing word segmentation for each sentence in the target document to obtain numberless words, temporarily not perform any filter processing for the numberless words; upon “obtaining, from a word material repository, word vectors of word materials corresponding to respective words” according to step (a1), if there is not a word material corresponding to a certain word in the word material repository, a corresponding word vector cannot be obtained, whereupon the word vector may be set as 0; the correlation between the 0 vector and a topic vector of any topic is defined as 0. As such, it can be guaranteed that words without corresponding word materials in the word material repository will not be extracted as keywords subsequently.

Further optionally, before step (a2) “obtaining topic vectors of respective topics from a preset topic vector repository”, the method may specifically further comprise the following steps:

(c1) obtaining topic identifiers corresponding to respective word materials;

(c2) training topic vectors of topics corresponding to respective topic identifiers, according to word vectors of respective word materials in the word material repository, the topic identifiers corresponding to respective word materials and the trained word vector model;

(c3) storing the topic vectors of respective topics in the topic vector repository.

Specifically, regarding each word material in the word material repository, it is feasible to predict a distribution probability of the document where the word material lies in the topics according to a topic model, determine the topic corresponding to the document, and thereby determine the topic corresponding to the word material. For example, it is feasible to select, from the distribution probabilities of respective topics, a topic identifier with a maximum distribution probability as the topic identifier of the document, and identify the topic as the topic identifier corresponding to the word material. Alternatively, it is also feasible to, according to distribution probabilities of respective topics predicted by the topic model, the first N topic identifiers with the maximum distribution probability as candidate topic identifiers, and then, in a random sampling manner, select from the N candidate topic identifiers a topic identifier as the topic identifier corresponding to the word material. For example, it is feasible to make statistics from a selected range in the document repository to figure out which one of the N candidate topic identifiers is the topic identifier corresponding to the word material, and consider it as the topic identifier corresponding to the word material. In the present embodiment, it is unnecessary to know an exact name of each topic, e.g., the topic is of education or science and technology or recreation or the like, and it is only necessary to know the topic identifier of the topic such as topic1 or topic2. As such, it is further feasible to identify the topic identifier of the word material in the word material repository, for example, a representation manner may be: word material-word material vector-times of occurrence-topic identifier.

Then, it is feasible to obtain topic vectors of topics corresponding to topic identifiers, according to word vectors of respective word materials already duly trained in the work material repository, topic identifiers corresponding to respective word materials and the word vector model after the training. Specifically, it is feasible to, according to information stored in the word material repository, obtain all word materials corresponding to each topic identifier, consider these word materials as positive word materials corresponding to the topic identifier, then further obtain, from the word material repository, some word materials not corresponding to the topic identifier as negative word materials corresponding to the topic identifier. Likewise, the number of the negative word materials may be four times or other integer times the number of positive word materials. Then, since the word vector model is already duly trained in the above embodiment, namely, parameters of the word vector model are already certain, the topic vector corresponding to the topic identifier may be trained according to the positive and negative word materials corresponding to the topic identifier; for example, the topic may be input into the duly-trained word vector model, and the word vector model outputs the topic vector of the topic. Then, judgment is made to a correlation between the topic vector and word vectors of the positive word materials of the topic and word vectors of negative word materials of the topic respectively; if the correlation between the topic vector and word vectors of the positive word materials corresponding to the topic identifier is smaller than a preset correlation threshold, or the correlation between the topic vector and word vectors of the negative word materials corresponding to the topic identifier is larger than or equal to a preset correlation threshold, values of elements in the topic vector are adjusted so that the correlation between the topic vector and word vectors of the positive word materials corresponding to the topic identifier is great than or equal to the preset correlation threshold, or the correlation between the topic vector and word vectors of the negative word materials corresponding to the topic identifier is smaller than the preset correlation threshold. An apparatus for extracting keywords based on artificial intelligence may obtain the topic vector of each topic after undergoing training many times. Finally, the topic vectors of respective topics are stored in the topic vector repository to facilitate acquisition upon subsequent use. The dimensions of the topic vector of the present embodiment are identical with the dimensions of the word vector.

102: extracting, from multiple words, words as keywords of the target document, according to distribution probabilities of respective words in respective topics and the correlation between word vectors of respective words and topic vectors of respective topics in multiple topics.

Regarding each word in the target document, the correlation between word vectors of respective words and topic vectors of respective topics can be obtained according to step 101, for example, it is feasible to calculate the correlation between word vectors of respective words and topic vectors of respective topics by calculating a cosine distance between the word vectors of the words and the topic vectors of respective topics. The larger the cosine distance is, the word is more related to the topic. Otherwise, the smaller the cosine distance is, the word is less related to the topic. In the present embodiment, when keywords are extracted, thoughts should be simultaneously given to distribution probabilities of respective words in respective topics and the correlation between word vectors of respective words and topic vectors of respective topics in multiple topics, to implement extracting, from multiple words, words as keywords of the target document.

For example, step 102 “extracting, from multiple words, words as keywords of the target document, according to distribution probabilities of respective words in respective topics and the correlation between word vectors of respective words and topic vectors of respective topics in multiple topics” may specifically comprise the following steps:

(d1) calculating generation probabilities of respective words in the target document, according to the distribution probabilities of respective words in respective topics and the correlation between word vectors of respective words and topic vectors of respective topics in multiple topics;

For example, step (d1) “calculating generation probabilities of respective words in the target document, according to the distribution probabilities of respective words in respective topics and the correlation between word vectors of respective words and topic vectors of respective topics in multiple topics” may specifically be implemented with the following formula:

$$p ( w \vert d ) = {\sum }_{z} cos 〈 w \vert z 〉 p ( z \vert d )$$

wherein p(w|d) represents a generation probability of a word w in the target document d, p(z|d) represents a distribution probability of the target document d in the topic z, and cos <w|z> represents a correlation between the word vector of the word w and the topic vector of the topic z.

That is to say, the generation probability of each word in the target document is equal to a sum obtained by summating products of “correlation between the word vector of the word and the topic vector” and distribution probabilities of corresponding topics, according to respective topics. In the present embodiment, if the correlation between the word vector of the word and the topic vector is larger, the word vector is closer to the topic; if the distribution probability of the word in the topic is larger, the word has a larger probability of belonging to the topic. Hence, in the present embodiment, it is feasible to construct the generation probability of the word in the target document according to the correlation between the word vector of the word and the topic vector and the distribution probability of the word in the topics so that thoughts are given to the correlation between the word and the topic as well as the probability of the topic corresponding to the word such that the generation probability of the word can characterize the importance of the word in the target document.

(d2) according to the generation probabilities of the respective words in the target document, extracting, from multiple words, words as keywords of the target document.

The generation probability of the word obtained in the above manner can more accurately characterize the importance of the word in the target document. Hence, a larger generation probability means the word is more important is the target document. On the contrary, a smaller generation probability means the word is less important in the target document. Regarding the multiple words in the target document, the generation probabilities of the words in the target document may be generated in the above manner. Then, it is feasible to rank the generation probabilities of the multiple words in the target document in a descending order, and extract k words from forward to backward as keywords of the target document. k in the present embodiment may be set according to actual needs, for example, the value of k may be set as 1, 3, 5 or other values.

According to the method of extracting keywords based on artificial intelligence according to the present embodiment, a distribution probability of the target document in each topic among multiple topics is predicted based on the topic model; calculation is conducted for correlation between word vectors of respective words in multiple words of the target document and topic vectors of respective topics in multiple topics, wherein the word vectors of respective words and topic vectors of respective topics are all generated based on a word vector model; words are extracted from multiple words as keywords of the target document, according to distribution probabilities of respective words in respective topics and the correlation between word vectors of respective words and topic vectors of respective topics in multiple topics. With the above technical solution being employed in the present embodiment, the extracted keywords are not high-frequency words, but are extracted according to the distribution probabilities of respective words in respective topics and the correlation between word vectors of respective words and topic vectors of respective topics in multiple topics, so that the extracted keywords are closer to the topic of the target document, more valid and more accurate.

For example, Table 1 below shows comparison of word frequency of keywords recalled by a topic model multinomial distribution p(w|z) in the prior art and the most neighboring words recalled in the vector space in the topic vector manner of the present embodiment. It can be found from the table that the word frequency of keywords recalled using the topic model in the prior art is higher, whereas the word frequency of keywords recalled in the present embodiment is not high and the keywords are closer to the topic and more accurate.

| Topic | | |
|---|---|---|
| serial | Topic model multinomial | Topic model multinomial |
| number | distribution | distribution |
| Topic1 | Taiwan (2332) People's Republic of | People First Party (2) Legislation Committee |
| | China (30904) Issues (19080) | (21) Two-states Theory (1) Tamper (42) |
| | Reunification (2165) Relationship | Willful (1) Hsieh Chang-ting (2) Annette Lu |
| | (6052) Principle (2256) Independence | (2) Beautify (141) Independence of Taiwan |
| | of Taiwan (20) People (4172) | (20) Ying-Wen Tsai (12) |
| | Mainland China (1125) Peace (699) | |
| Topic2 | Space (4507) Satellite (244) | Battery (484) Spacecraft (10) Sun (1686) |
| | Technology (9673) System (7348) | Antenna (156) Circuit (259) Spaceship (121) |
| | Country (10619) International (5937) | Optics (97) Sensor (221) Physics (120) |
| | Research (6571) Data (3845) Utilize | Satellite (244) |
| | (4035) Globe (1170) | |
| Topic3 | Children (2950) Women (1053) | Drug addicts (12) Prenatal (35) Cancer (676) |
| | Violence (490) Committee (936) | Diarrhea (310) Teenagers (617) Girls (2160) |
| | Behavior (4218) Family (3918) | Sexual abuse (4) Parents (2431) Minors (63) |
| | Society (10239) Government (6141) | Zhu Lin (5) |
| | Measures (1734) Rights (1565) | |
| Topic4 | The Central Committee of the Party | Hebei Province (993) Deputy province |
| | (1838) Conference (2004) Work | governor (40) Shenyang (657) Bureau of |
| | (18347) People (4172) The Chinese | Public Security (384) Deputy mayor (118) |
| | Communist Party (436) The National | Deputy secretary (106) Deputy Director (191) |
| | People's Congress (408) Deputies to | Hubei (585) The Commission for Discipline |
| | the National People's Congress (3986) | Inspection (100) Accept bribes (125) |
| | Today (8322) The State Council (970) | |
| | State councilor (493) | |

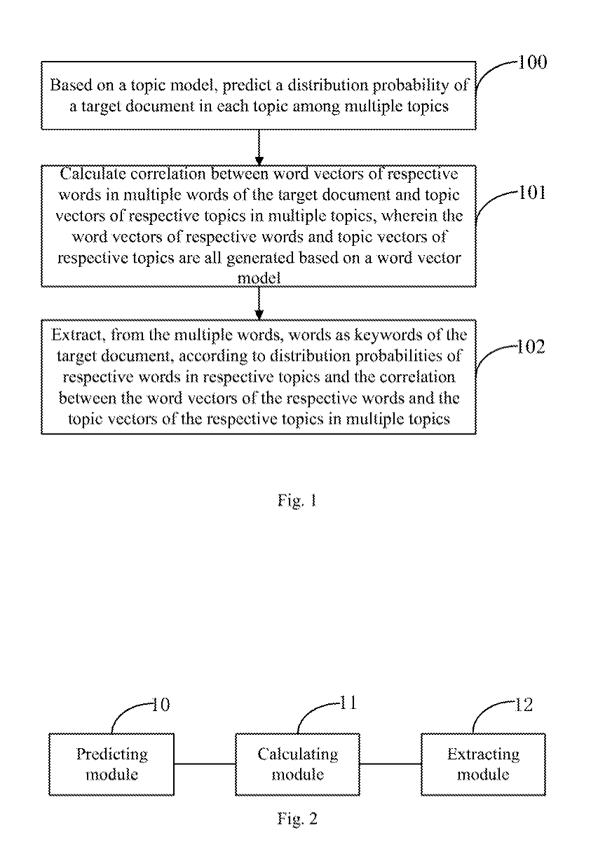

FIG. 2 is structural diagram of a first embodiment of an apparatus for extracting keywords based on artificial intelligence according to the present disclosure. As shown in FIG. 2, the apparatus for extracting keywords based on artificial intelligence according to the present embodiment may specifically comprise: a predicting module 10, a calculating module 11 and an extracting module 12.

The predicting module 10 is configured to, based on a topic model, predict a distribution probability of a target document in each topic among multiple topics; the calculating module 11 is configured to calculate correlation between word vectors of respective words in multiple words of the target document and topic vectors of respective topics in multiple topics, wherein the word vectors of respective words and topic vectors of respective topics are all generated based on a word vector model; the extracting module 12 is configured to extract, from multiple words, words as keywords of the target document, according to distribution probabilities of respective words in respective topics as calculated by the predicting module 10 and the correlation between word vectors of respective words and topic vectors of respective topics in multiple topics as calculated by the calculating model 11.

Principles employed by the apparatus for extracting keywords based on artificial intelligence with the above modules to achieve artificial intelligence-based keyword extraction and the resultant technical effects are the same as those of the above-mentioned method embodiments. For particulars, please refer to the depictions of the aforesaid relevant method embodiments, and no detailed depictions will be presented here.

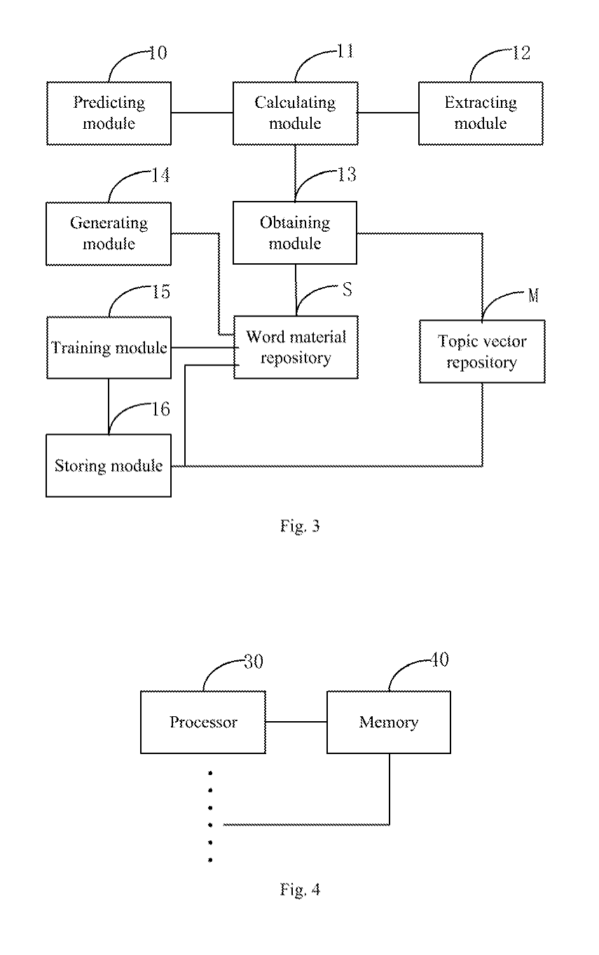

FIG. 3 is structural diagram of a second embodiment of an apparatus for extracting keywords based on artificial intelligence according to the present disclosure. As shown in FIG. 3, the apparatus for extracting keywords based on artificial intelligence of the present embodiment, on the basis of the technical solution of the embodiment shown in FIG. 2, further introduces the technical solution of the present disclosure in more detail.

In the apparatus for extracting keywords based on artificial intelligence according to the present embodiment, the extracting module 12 is specifically configured to:

calculate generation probabilities of respective words in the target document, according to distribution probabilities of respective words in respective topics as predicted by the predicting module 10 and correlation between word vectors of respective words and topic vectors of respective topics in multiple topics as calculated by the calculating module 11;

according to the generation probabilities of the respective words in the target document, extract, from multiple words, words as keywords of the target document.

Further optionally, in the apparatus for extracting keywords based on artificial intelligence according to the present embodiment, the calculating module 11 is specifically configured to calculate using the following formula:

$$p ( w \vert d ) = {\sum }_{z} cos 〈 w \vert z 〉 p ( z \vert d )$$

wherein p(w|d) represents a generation probability of a word w in the target document d, p(z|d) represents a distribution probability of the target document d in the topic z, and cos <w|z> represents a correlation between the word vector of the word w and the topic vector of the topic z.

Further optionally, as shown in FIG. 3, the apparatus for extracting keywords based on artificial intelligence according to the present embodiment further comprises:

an obtaining module 13 configured to obtain, from a preset word material repository, word vectors of word materials corresponding to respective words;

the obtaining module 13 further configured to obtain topic vectors of respective topics from a preset topic vector repository.

Correspondingly, the calculating module 11 is configured to calculate correlation between word vectors of respective words in multiple words of the target document as obtained by the obtained module 13 and topic vectors of respective topics in multiple topics obtained by the obtaining module 13.

Further optionally, as shown in FIG. 3, the apparatus for extracting keywords based on artificial intelligence according to the present embodiment further comprises:

a generating module 14 configured to generate the word material repository S including several word materials, according to a preset document repository including multiple documents;

a training module 15 configured to train the word vector model and word vectors of respective word materials, according to respective word materials in the word material repository S generated by the generating module 14 and co-occurrence information of the word materials with other word materials in respective documents in the document repository;

a storing module 16 configured to store word vectors of respective word materials trained by the training module 15 in the word material repository S generated by the generating module 14.

Correspondingly, the obtaining module 13 is configured to obtain word vectors of word materials corresponding to respective words from the word material repository S after the processing of the generating module 14 and the storing module 16.

Further optionally, as shown in FIG. 3, the apparatus for extracting keywords based on artificial intelligence according to the present embodiment further comprises: the obtaining module 13 is further configured to obtain topic identifiers corresponding to respective word materials;

the training module 15 is further configured to obtain topic vectors of topics corresponding to respective topic identifiers, according to word vectors of respective word materials in the word material repository S after the processing of the generating module 14 and the storing module 16, the topic identifiers corresponding to respective word materials and the trained word vector model;

the storing module 16 is further configured to store the topic vectors of respective topics obtained from the training of the training module 15 in the topic vector repository M.

Correspondingly, the obtaining module 13 is further configured to obtain topic vectors of respective topics from the topic vector repository M processed by the storing module 16.

Principles employed by the apparatus for extracting keywords based on artificial intelligence with the above modules to achieve artificial intelligence-based keyword extraction and the resultant technical effects are the same as those of the above-mentioned method embodiments. For particulars, please refer to the depictions of the aforesaid relevant method embodiments, and no detailed depictions will be presented here.

FIG. 4 is a structural diagram of an embodiment of a computer device according to the present disclosure. As shown in FIG. 4, the computer device according to the present embodiment comprises: one or more processors 30, and a memory 40 for storing one or more programs, wherein the one or more programs stored in the memory 40, when executed by said one or more processors 30, enabling said one or more processors 30 to implement the method of extracting keywords based on artificial intelligence of the embodiments as shown in FIG. 1-FIG. 3. The embodiment shown in FIG. 4 exemplarily includes a plurality of processors 30.

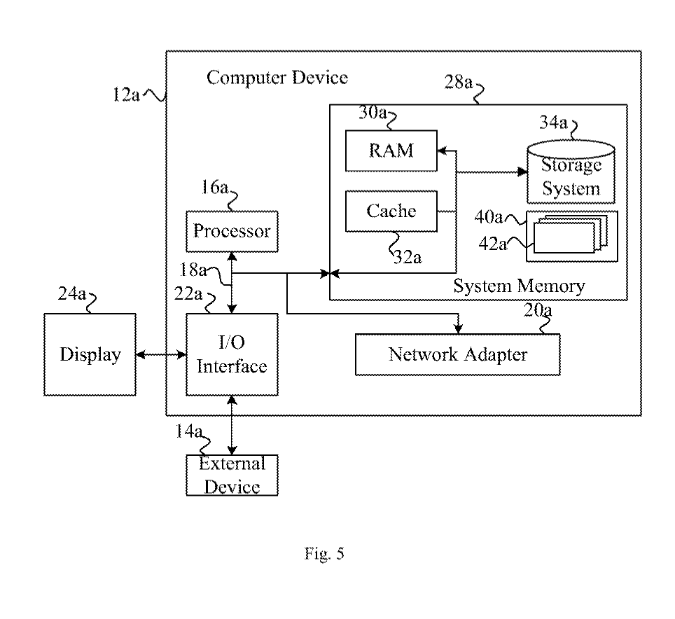

For example, FIG. 5 is an example diagram of a computer device according to the present disclosure. FIG. 5 shows a block diagram of an example computer device 12a adapted to implement an implementation mode of the present disclosure. The computer device 12a shown in FIG. 5 is only an example and should not bring about any limitation to the function and scope of use of the embodiments of the present disclosure.

As shown in FIG. 5, the computer device 12a is shown in the form of a general-purpose computing device. The components of computer device 12a may include, but are not limited to, one or more processors 16a, a system memory 28a, and a bus 18a that couples various system components including the system memory 28a and the processors 16a.

Bus 18a represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer device 12a typically includes a variety of computer system readable media. Such media may be any available media that is accessible by computer device 12a, and it includes both volatile and non-volatile media, removable and non-removable media.

The system memory 28a can include computer system readable media in the form of volatile memory, such as random access memory (RAM) 30a and/or cache memory 32a. Computer device 12a may further include other removable/non-removable, volatile/non-volatile computer system storage media. By way of example only, storage system 34a can be provided for reading from and writing to a non-removable, non-volatile magnetic media (not shown in FIG. 5 and typically called a “hard drive”). Although not shown in FIG. 5, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 18a by one or more data media interfaces. The system memory 28a may include at least one program product having a set (e.g., at least one) of program modules that are configured to carry out the functions of embodiments shown in FIG. 1-FIG. 3 of the present disclosure.

Program/utility 40a, having a set (at least one) of program modules 42a, may be stored in the system memory 28a by way of example, and not limitation, as well as an operating system, one or more disclosure programs, other program modules, and program data. Each of these examples or a certain combination thereof might include an implementation of a networking environment. Program modules 42a generally carry out the functions and/or methodologies of embodiments shown in FIG. 1-FIG. 3 of the present disclosure.

Computer device 12a may also communicate with one or more external devices 14a such as a keyboard, a pointing device, a display 24a, etc.; with one or more devices that enable a user to interact with computer device 12a; and/or with any devices (e.g., network card, modem, etc.) that enable computer device 12a to communicate with one or more other computing devices. Such communication can occur via Input/Output (I/O) interfaces 22a. Still yet, computer device 12a can communicate with one or more networks such as a local area network (LAN), a general wide area network (WAN), and/or a public network (e.g., the Internet) via network adapter 20a. As depicted in FIG. 5, network adapter 20a communicates with the other communication modules of computer device 12a via bus 18a. It should be understood that although not shown, other hardware and/or software modules could be used in conjunction with computer device 12a. Examples, include, but are not limited to: microcode, device drivers, redundant processing units, external disk drive arrays, RAID systems, tape drives, and data archival storage systems, etc.

The processor 16a executes various function applications and data processing by running programs stored in the system memory 28a, for example, implements the method of extracting keywords based on artificial intelligence shown in the above embodiments.

The present disclosure further provides a computer readable medium on which a computer program is stored, the program, when executed by a processor, implementing the method of extracting keywords based on artificial intelligence shown in the above embodiments.

The computer readable medium of the present embodiment may include RAM 30a, and/or cache memory 32a and/or a storage system 34a in the system memory 28a in the embodiment shown in FIG. 5.

As science and technology develops, a propagation channel of the computer program is no longer limited to tangible medium, and it may also be directly downloaded from the network or obtained in other manners. Therefore, the computer readable medium in the present embodiment may include a tangible medium as well as an intangible medium.

The computer-readable medium of the present embodiment may employ any combinations of one or more computer-readable media. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium can be any tangible medium that include or store programs for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In the embodiments provided by the present disclosure, it should be understood that the revealed system, apparatus and method can be implemented in other ways. For example, the above-described embodiments for the apparatus are only exemplary, e.g., the division of the units is merely logical one, and, in reality, they can be divided in other ways upon implementation.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, Read-Only Memory (ROM), a Random Access Memory (RAM), magnetic disk, or an optical disk.

What are stated above are only preferred embodiments of the present disclosure and not intended to limit the present disclosure. Any modifications, equivalent substitutions and improvements made within the spirit and principle of the present disclosure all should be included in the extent of protection of the present disclosure.

What is claimed is:

1. A method for extracting keywords based on artificial intelligence, wherein the method comprises:
predicting a distribution probability of a target document in each of multiple topics based on a topic model;
calculating correlation between word vectors of respective words in multiple words of the target document and topic vectors of respective topics in the multiple topics, wherein the word vectors of the respective words and the topic vectors of the respective topics are all generated based on a word vector model;
extracting, from the multiple words, words as keywords of the target document, according to distribution probabilities of the respective words in the respective topics and the correlation between the word vectors of the respective words and the topic vectors of the respective topics in the multiple topics.

2. The method according to claim 1, wherein the extracting, from the multiple words, words as keywords of the target document, according to distribution probabilities of the respective words in the respective topics and the correlation between the word vectors of the respective words and the topic vectors of the respective topics in the multiple topics specifically comprises:
calculating generation probabilities of the respective words in the target document, according to distribution probabilities of respective words in respective topics and correlation between word vectors of respective words and topic vectors of respective topics in multiple topics;
according to the generation probabilities of the respective words in the target document, extracting, from the multiple words, words as keywords of the target document.

3. The method according to claim 1, wherein before calculating correlation between word vectors of respective words in multiple words of the target document and topic vectors of respective topics in the multiple topics, the method further comprises:
obtaining, from a preset word material repository, word vectors of word materials corresponding to the respective words;
obtaining topic vectors of the respective topics from a preset topic vector repository.

4. The method according to claim 3, wherein before obtaining, from a preset word material repository, word vectors of word materials corresponding to the respective words, the method further comprises:
generating word material repository including several word materials, according to a preset document repository including multiple documents;
training the word vector model and word vectors of the respective word materials, according to the respective word materials in the word material repository and co-occurrence information of the word materials with other word materials in respective documents in the document repository;
storing word vectors of the respective word materials in the word material repository.

5. The method according to claim 3, wherein before obtaining topic vectors of the respective topics from a preset topic vector repository, the method further comprises:
obtaining topic identifiers corresponding to the respective word materials;
according to word vectors of the respective word materials in the word material repository, topic identifiers corresponding to the respective word materials and the trained word vector model, training topic vectors of topics corresponding to the respective topic identifiers;
storing topic vectors of the respective topics in the topic vector repository.

6. A computer device, wherein the device comprises:
one or more processors,
a memory for storing one or more programs,
the one or more programs, when executed by said one or more processors, enabling said one or more processors to implement the following operation:
predicting a distribution probability of a target document in each of multiple topics, based on a topic model;
calculating correlation between word vectors of respective words in multiple words of the target document and topic vectors of respective topics in the multiple topics, wherein the word vectors of the respective words and the topic vectors of the respective topics are all generated based on a word vector model;
extracting, from the multiple words, words as keywords of the target document, according to distribution probabilities of the respective words in the respective topics and the correlation between the word vectors of the respective words and the topic vectors of the respective topics in the multiple topics.

7. The computer device according to claim 6, wherein the operation of extracting, from the multiple words, words as keywords of the target document, according to distribution probabilities of the respective words in the respective topics and the correlation between the word vectors of the respective words and the topic vectors of the respective topics in the multiple topics specifically comprises:
calculating generation probabilities of the respective words in the target document, according to distribution probabilities of respective words in respective topics and correlation between word vectors of respective words and topic vectors of respective topics in multiple topics;
according to the generation probabilities of the respective words in the target document, extracting, from the multiple words, words as keywords of the target document.

8. The computer device according to claim 6, wherein before calculating correlation between word vectors of respective words in multiple words of the target document and topic vectors of respective topics in the multiple topics, the operation further comprises:
obtaining, from a preset word material repository, word vectors of word materials corresponding to the respective words;
obtaining topic vectors of the respective topics from a preset topic vector repository.

9. The computer device according to claim 8, wherein before obtaining, from a preset word material repository, word vectors of word materials corresponding to the respective words, the operation further comprises:
generating word material repository including several word materials, according to a preset document repository including multiple documents;
training the word vector model and word vectors of the respective word materials, according to the respective word materials in the word material repository and co-occurrence information of the word materials with other word materials in respective documents in the document repository;
storing word vectors of the respective word materials in the word material repository.

10. The computer device according to claim 8, wherein before obtaining topic vectors of the respective topics from a preset topic vector repository, the operation further comprises:
obtaining topic identifiers corresponding to the respective word materials;
according to word vectors of the respective word materials in the word material repository, topic identifiers corresponding to the respective word materials and the trained word vector model, training topic vectors of topics corresponding to the respective topic identifiers;
storing topic vectors of the respective topics in the topic vector repository.

11. A computer readable medium on which a computer program is stored, wherein the program, when executed by a processor, implements the following operation:
predicting a distribution probability of a target document in each topic among multiple topics, based on a topic model;
calculating correlation between word vectors of respective words in multiple words of the target document and topic vectors of respective topics in the multiple topics, wherein the word vectors of the respective words and the topic vectors of the respective topics are all generated based on a word vector model;
extracting, from the multiple words, words as keywords of the target document, according to distribution probabilities of the respective words in the respective topics and the correlation between the word vectors of the respective words and the topic vectors of the respective topics in the multiple topics.

12. The computer readable medium according to claim 11, wherein the operation of extracting, from the multiple words, words as keywords of the target document, according to distribution probabilities of the respective words in the respective topics and the correlation between the word vectors of the respective words and the topic vectors of the respective topics in the multiple topics specifically comprises:
calculating generation probabilities of the respective words in the target document, according to distribution probabilities of respective words in respective topics and correlation between word vectors of respective words and topic vectors of respective topics in multiple topics;
according to the generation probabilities of the respective words in the target document, extracting, from the multiple words, words as keywords of the target document.

13. The computer readable medium according to claim 11, wherein before calculating correlation between word vectors of respective words in multiple words of the target document and topic vectors of respective topics in the multiple topics, the operation further comprises:
obtaining, from a preset word material repository, word vectors of word materials corresponding to the respective words;
obtaining topic vectors of the respective topics from a preset topic vector repository.

14. The computer readable medium according to claim 13, wherein before obtaining, from a preset word material repository, word vectors of word materials corresponding to the respective words, the operation further comprises:
generating word material repository including several word materials, according to a preset document repository including multiple documents;
training the word vector model and word vectors of the respective word materials, according to the respective word materials in the word material repository and co-occurrence information of the word materials with other word materials in respective documents in the document repository,
storing word vectors of the respective word materials in the word material repository.

15. The computer readable medium according to claim 13, wherein before obtaining topic vectors of the respective topics from a preset topic vector repository, the operation further comprises:
obtaining topic identifiers corresponding to the respective word materials;
according to word vectors of the respective word materials in the word material repository, topic identifiers corresponding to the respective word materials and the trained word vector model, training topic vectors of topics corresponding to the respective topic identifiers;
storing topic vectors of the respective topics in the topic vector repository.
